(19) United States
(12) Patent Application Publication
(10) Pub. No.: US 2016/0034898 A1
(43) Pub. Date: Feb. 4, 2016

(54) Systems and Methods for Identifying Merchants that Pose Transaction Risks to Purchasing Entities

(71) Applicant: MASTERCARD INTERNATIONAL INCORPORATED, Purchase, NY (US)

(72) Inventor: Debashis Ghosh, Charlotte, NC (US)

(21) Appl. No.: 14/449,438

(22) Filed: Aug. 1, 2014

(51) Int. Cl. G06Q 20/40

(52) U.S. Cl. CPC G06Q 20/4016

(57) ABSTRACT

Systems and methods are provided for identifying when a merchant poses a transaction risk to a purchasing entity. One exemplary method includes receiving a request to review a merchant to determine if the merchant poses a transaction risk to a purchasing entity, and searching for the merchant in a merchant database. The merchant database includes merchant data for multiple merchants that are associated with risk events indicative that the multiple merchants pose transaction risks to the purchasing entity. The method also includes flagging the merchant when the merchant is identified in the merchant database.

### FIELD

The present disclosure generally relates to systems and methods for identifying merchants that pose transaction risks to purchasing entities.

### BACKGROUND

This section provides background information related to the present disclosure which is not necessarily prior art.

Various entities, for example, the Better Business Bureau, etc., monitor interactions between consumers and merchants, and assign ratings to the merchants based on satisfaction of the consumers with the interactions. Similarly, consumers often provide reviews, comments, feedback, etc. about merchants, and interactions with the merchants, on social media sites such as Yelp®, Twitter®, and Facebook®. Separately, merchants, in financial trouble, often file for bankruptcy as a means of protection from creditors (e.g., consumers, other merchants, etc.), and as a means to provide distributions of assets to the creditors through reorganization, liquidation, etc. Many merchants cease activity following such bankruptcy filings. However, some merchants continue in business, after satisfying various bankruptcy requirements, under the same business names or under new business names.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in identifying when a merchant poses a transaction risk to a purchasing entity;

FIG. 2 is a block diagram of a computing device, that may be used in the exemplary system of FIG. 1;

FIG. 3 is an exemplary method for use in identifying when a merchant poses a transaction risk to a purchasing entity; and

FIGS. 4-6 are exemplary portions of interfaces that can be displayed at the computing device in connection with the system of FIG. 1 and/or the method of FIG. 3.

Corresponding reference numerals indicate corresponding parts throughout the several views of the drawings.

### DETAILED DESCRIPTION

The description and specific examples included herein are intended for purposes of illustration only and are not intended to limit the scope of the present disclosure.

Consumers often enter into transactions with merchants to purchase services and goods from the merchants. In some cases, however, the merchants may be in distress or may be untrustworthy, and are unable or unwilling to provide the services and goods to the consumers following the transactions. For example, the merchants may be financially stressed (e.g., the merchants may be in bankruptcy, etc.), the merchants may be fraudulent, etc. As can be appreciated, entering into transactions with such distressed or untrustworthy merchants can result in loss to the consumers. Thus, it is desirable for the consumers to know, prior to completing a transaction, whether the merchants, with whom they plan to transact, pose such risks. Systems and methods described herein identify such merchants, before the consumers complete transactions with the merchants, thereby protecting the consumers from potentially failed transactions.

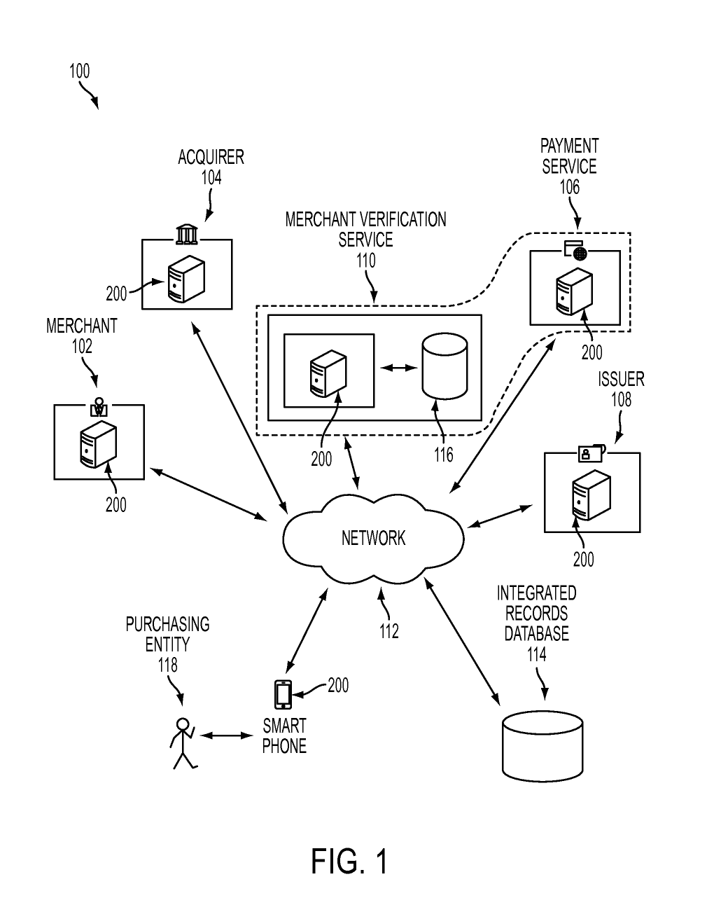

With reference now to the drawings, FIG. 1 illustrates an exemplary system 100, in which one or more aspects of the present disclosure may be implemented. Although components of the system 100 are presented in one arrangement, it should be appreciated that other exemplary embodiments may include the same or different components arranged otherwise, for example, depending on the merchant verification service's association with one or more of the purchasing entities, merchants, acquirers, payment services, and/or issuers, etc.

The illustrated system 100 generally includes a merchant 102, an acquirer 104, a payment service 106, an issuer 108, and a merchant verification service 110, each coupled to network 112. The network 112 may include, without limitation, a wired and/or wireless network, one or more local area network (LAN), wide area network (WAN) (e.g., the Internet, etc.), other network(s) as described herein, and/or other suitable public and/or private network(s) capable of supporting communication among two or more of the illustrated components, or any combination thereof. In one example, the network 112 includes multiple networks, where different ones of the multiple networks are accessible to different ones of the illustrated components in FIG. 1.

The merchant verification service 110 identifies merchants, from an integrated records database 114, that have experienced or are associated with one or more risk events (including, if applicable, the merchant 102). In the illustrated system 100, the integrated records database 114 generically represents various different available sources of such merchants, including both public and private sources (e.g., sources such as other consumers, other merchants, consumer protection groups, social media sites, court records, etc.), and includes indications of risk events associated therewith. Information from the integrated records database 114 can be captured, as desired, for example, via manual entry of data from the various sources, via websites associated with such sources, via databases associated with such sources, etc. It is contemplated that the merchant verification service 110 will track (e.g., continuously monitor, track at select time intervals, etc.) all available merchants to determine which, if any, pose a risk (e.g., currently, in the future, etc.) or are associated with a risk event. And, the merchant verification service 110 will then will include (or identify) all available merchants, from the integrated records database 114, that pose (or may pose) a risk or are associated with a risk event.

The risk events used, by the merchant verification service 110, to identify the merchants in the integrated records database 114 that pose a risk (or that may pose a risk) to a future (or potential) transaction with the merchant can include, without limitation, bankruptcy filings, bankruptcy judgments, delivery and/or cancellation records (e.g., as reported by the merchants, as reported by other consumers or merchants, as reported by other entities, etc.), consumer/merchant risk assessments (e.g., from the Better Business Bureau; Consumer Reports; Kealhofer, McQuown and Vasicek (KMV) as part of Moody's Analytics; etc., or via social media sites such as Yelp®, Twitter®, and Facebook®, etc.), etc. And, merchant data, including, for example, the merchant's name, the merchant's address, the merchant's merchant identification number (MID), etc. is then collected and stored in a merchant database 116 associated with the merchant verification service 110 for subsequent use. As such, the merchant database 116 includes a compilation of merchants, found by the merchant verification service 110, that may pose transaction risks to purchasing entities (e.g., the purchasing entity 118, other purchasing entities, etc.). And, the risk events for merchants are associated with the corresponding merchants in the merchant database 116. It is contemplated that only merchants associated with a risk event will be included in the merchant database 116. However, in some embodiments, other merchants may still be included (even if not associated with a risk event) within the scope of the present disclosure.

As an example, one of the merchants identified by the merchant verification service 110 may include a roofing company that has recently filed for bankruptcy. Here, if a purchasing entity (e.g., purchasing entity 118 such as a consumer, another merchant or business, etc.) enters a contract with the roofing company to roof a home (which often requires a down payment from the purchasing entity 118), the roofing company poses a risk to the purchasing entity 118 in that the roofing company may not have the resources necessary to roof the home and/or may be on the verge of ceasing operation. As another example, one of the merchants identified by the merchant verification service 110 may include a furniture store that has recently filed for bankruptcy. Here, if the purchasing entity 118 buys furniture from the store along with a warranty, the store poses a risk to the purchasing entity 118 in that the furniture store may no longer have the resources necessary to honor the warranty.

In the illustrated embodiment, the merchant verification service 110 is shown separate from the other entities in the system 100. However, it should be understood that the merchant verification service 110 could be implemented in combination with one or more of the other entities in the system 100, such as, for example, the payment service 106 (as indicated by the broken lines in FIG. 1), etc., or with one or more other entities not shown (e.g., manufacturers or providers of products and/or services provided by the merchant 102, etc.).

With continued reference to FIG. 1, in the illustrated system 100, the purchasing entity 118 is capable of completing a payment transaction with the merchant 102 using a payment device. In particular, the merchant 102, the acquirer 104, the payment service 106, and the issuer 108 cooperate, in response to the purchasing entity 118 (e.g., a purchase by the purchasing entity 118), to complete the payment transaction at the merchant 102 for a product and/or service. Typically, the purchasing entity 118 initiates the transaction by presenting the payment device, issued by the issuer 108, to the merchant 102. The payment device may include any suitable device such as, for example, a payment card (e.g., a credit card, a debit card, a pre-paid card, etc.), a payment token, a payment tag, a pass, another enabled device used to provide an account number (e.g., a mobile phone, a tablet, etc.), etc.

In response, the merchant 102 reads the payment device (and, in some cases, requests a personal identification number (PIN) to authorize the payment device) and communicates, via the network 112, an authorization request, including details of the transaction, to the acquirer 104 to determine whether the payment device is in good standing and whether there is sufficient credit to complete the transaction. The transaction details may include, for example, an account number, a purchase amount, a time of the purchase, a date of the purchase, other necessary account data included on the payment device, merchant data, etc. Following receipt of the authorization request, the acquirer 104, in turn, communicates with the issuer 108, through the payment service 106 (e.g., through a credit card payment system using the MasterCard® interchange, etc.), for authorization to complete the transaction. If the issuer 108 accepts the transaction, an authorization is provided back to the merchant 102 and the merchant 102 completes the transaction.

In one aspect of the system 100, when the authorization request is communicated through the payment service 106, the payment service 106 in turn communicates, via the network 112, a request to the merchant verification service 110 to determine if the merchant 102 identified in the authorization request (e.g., a target merchant, etc.) poses a transaction risk to the purchasing entity 118. Broadly, this includes a request by the payment service 106 to verify the merchant 102. In response to the request, the merchant verification service 110 searches the merchant database 116 for the merchant 102 and communicates the search results back to the payment service 106. Then, prior to completion of the payment transaction, the payment service 106 provides a notification to the purchasing entity 118 indicating whether or not the merchant 102 was identified in the search and poses a transaction risk. The notification may be provided directly to the purchasing entity 118, via the network 112, or it may be provided to the purchasing entity 118 via the merchant 102 (e.g., in connection with the authorization provided back to the merchant 102, for display to the purchasing entity 118 at a point of sale terminal, etc.). Alternatively, prior to completion of the payment transaction, the payment service 106 may provide a notification only when the merchant 102 was identified in the search as posing a transaction risk. The purchasing entity 118 can then either approve or cancel the payment transaction, based on the content of the notification. As such, the purchasing entity 118 is made aware of any risk events associated with the merchant 102 prior to completing the payment transaction.

In another aspect of the system 100, prior to initiating the payment transaction with the merchant 102 (and independent of a payment transaction), the purchasing entity 118 can also communicate, via the network 112, a request to the merchant verification service 110 to determine if the merchant 102 poses a transaction risk to the purchasing entity 118 (again, broadly, a request to verify the merchant 102). In response, the merchant verification service 110 searches the merchant database 116 for the merchant 102 and communicates the search results back to the purchasing entity 118, indicating whether or not the merchant 102 was identified in the search and poses a transaction risk. In so doing, the purchasing entity 118 is again made aware of any risk events associated with the merchant 102 and, thus, any potential risk associated with initiating the payment transaction with the merchant 102.

While a single merchant 102 is shown in the system 100 of FIG. 1, it should be appreciated that the system 100 can be implemented to verify multiple different merchants with whom the purchasing entity 118 may interact. Likewise, while one purchasing entity 118 is shown in the system 100 of FIG. 1, it should be appreciated that any number of purchasing entities may be included, and accommodated by the system 100.

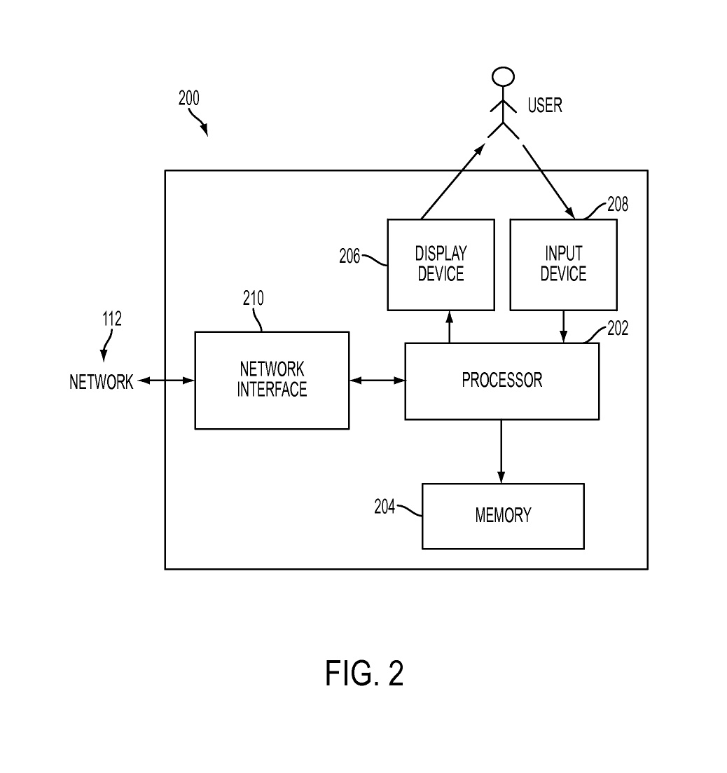

FIG. 2 illustrates an exemplary computing device 200. In the exemplary embodiment of FIG. 1, each of the merchant 102, the acquirer 104, the payment service 106, the issuer 108, the merchant verification service 110, and the purchasing entity 118 are illustrated as including or being associated with a computing device 200. The computing device 200 may include, for example, one or more servers, personal computers, laptops, tablets, PDAs, smartphones, etc. as appropriate.

The system 100, and its components, however, should not be considered to be limited to the computing device 200, as described below, as different computing devices and/or arrangements of computing devices may be used. In addition, different components and/or arrangements of components may be used in other computing devices. Further, in various exemplary embodiments the computing device 200 may include multiple computing devices located in close proximity, or distributed over a geographic region. Additionally, each computing device 200 may be coupled to a network (e.g., the Internet, an intranet, a private or public LAN, WAN, mobile network, telecommunication networks, combinations thereof, or other suitable network, etc.) that is either part of the network 112, or separate therefrom.

The exemplary computing device 200 includes a processor 202 and a memory 204 that is coupled to the processor 202. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and thus are not intended to limit in any way the definition and/or meaning of processor.

The memory 204, as described herein, is one or more devices that enable information, such as executable instructions and/or other data, to be stored and retrieved. The memory 204 may include one or more computer-readable media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, flash drives, hard disks, and/or any other type of volatile or nonvolatile physical or tangible computer-readable media. The memory 204 may be configured to store, without limitation, merchant data, payment transaction data, risk events for merchants, notification logs, and/or other types of data suitable for use as described herein, etc. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer-readable media. It should be appreciated that the memory 204 may include a variety of different memories, each implemented in one or more of the functions or processes described herein.

In the exemplary embodiment, the computing device 200 includes a display device 206 that is coupled to the processor 202. The display device 206 outputs to a user (e.g., the purchasing entity 118, individuals associated with the merchant 102, individuals associated with the acquirer 104, individuals associated with the payment service 106, individuals associated with the issuer 108, individuals associated with the merchant verification service 110, etc.) by, for example, displaying and/or otherwise outputting information such as, but not limited to, payment transaction data, merchant data, merchant listings, notifications, risk events associated with merchants, purchase confirmation options, and/or any other type of data. It should be further appreciated that various interfaces (e.g., webpages, etc.) may be displayed at computing device 200, and in particular at display device 206, to display such information, etc. And in some cases, the computing device 200 may cause the pages to be displayed at the display device 206 of another computing device, including, for example, a server hosting a website having multiple webpages, etc. Display device 206 may include, without limitation, a cathode ray tube (CRT), a liquid crystal display (LCD), a light-emitting diode (LED) display, an organic LED (OLED) display, and/or an “electronic ink” display. In some embodiments, display device 206 includes multiple devices.

The computing device 200 also includes an input device 208 that receives input from the user. The input device 208 is coupled to the processor 202 and may include, for example, a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both display device 206 and input device 208.

In addition, the illustrated computing device 200 also includes a network interface 210 coupled to the processor 202 and the memory 204. The network interface 210 may include, without limitation, a wired network adapter, a wireless network adapter, a mobile telecommunications adapter, or other device capable of communicating to one or more different networks, including the network 112. In some exemplary embodiments, the computing device 200 includes the processor 202 and one or more network interfaces incorporated into or with the processor 202.

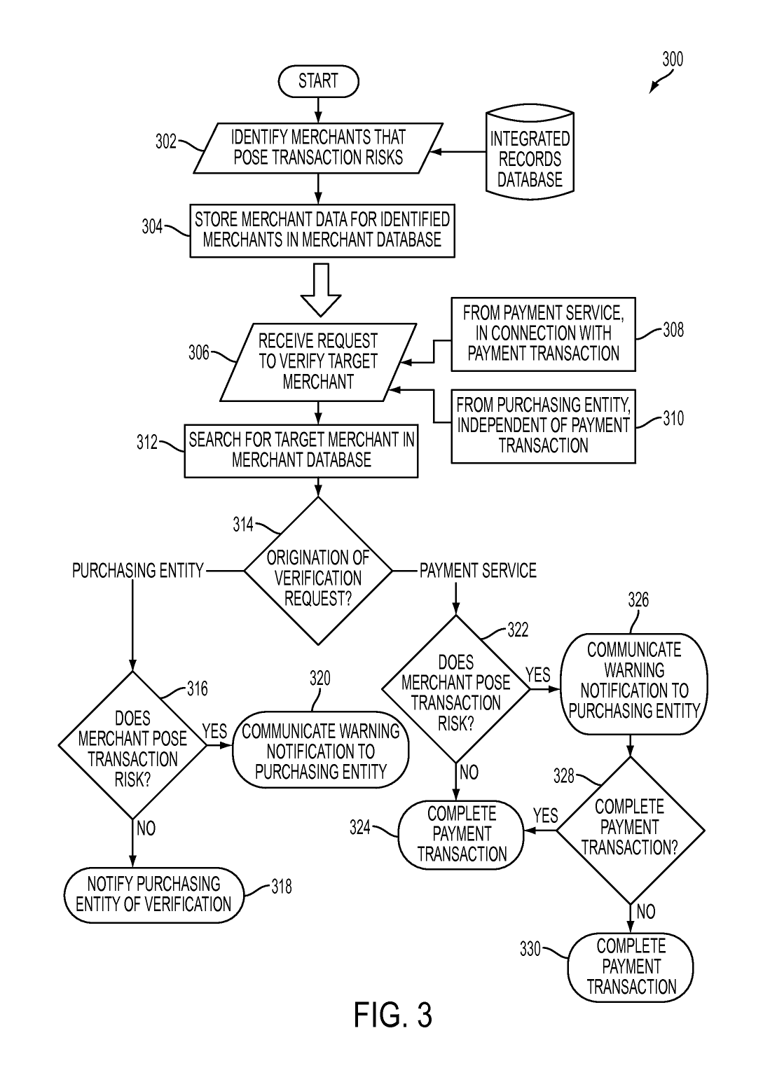

FIG. 3 illustrates an exemplary method at 300 for identifying merchants that pose transaction risks to purchasing entities. The exemplary method 300 is described as implemented in the merchant verification service 110 of the system 100, with further reference to the merchant 102, the acquirer 104, the payment service 106, the issuer 108, and the purchasing entity 118 (and the payment transactions therebetween). In at least some embodiments, the merchant verification service 110 may be included with the payment service 106 (again, as illustrated by the broken lines in FIG. 1). In other embodiments, the merchant verification service 110 may be stand alone, or associated with other entities, shown or not shown in FIG. 1, such as the acquirer 104, the issuer 108, manufacturers, or other entities involved in transactions for commodities with merchants.

Further, for purposes of illustration, the exemplary method 300 is described herein with reference to the computing device 200. And, just as the methods herein should not be understood to be limited to the exemplary system 100, or the exemplary computing device 200, the systems and the computing devices herein should not be understood to be limited to the exemplary method 300.

As shown in FIG. 3, the merchant verification service 110, via the computing device 200, initially identifies merchants at 302 from the integrated records database 114 that have experienced or are associated with one or more risk events (and that either pose a risk or may pose a risk to the purchasing entity 118). As previously described, the risk events triggering such identification may include, without limitation, bankruptcy filings, bankruptcy judgments, delivery and/or cancellation records, consumer/merchant risk assessments, etc. All available merchants, through the integrated records database 114, are tracked to identify/determine which, if any, may pose a risk. Merchant data for the identified merchants is then collected, for example by web scraping of websites or manual data collection, and stored in the merchant database 116, at 304, with the particular risk events triggering identification of the various merchants appended thereto. As part of collecting and storing the merchant data, the merchant verification service 110, at the computing device 200 (e.g., through the processor 202 of the computing device 200, etc.), also indexes the merchant data, to help categorize the data and allow for subsequent retrieval and use. Such indexing may be based on a variety of different information including, for example, merchant name, merchant address, MID, etc. Further, for merchants that have changed their names (e.g., following bankruptcy judgments, for other reasons, etc.) or have numerous divisions, etc., any prior business names associated with the merchants as well as the names of the other divisions may also be included in the merchant database 116 and associated with the merchants (for use in subsequent searches in the database 116).

When desired to determine if the merchant 102 (e.g., the target merchant, etc.) poses a transaction risk to the purchasing entity 118 (broadly, when desired to verify the merchant 102), a request is submitted to, and received by, the merchant verification service 110, at 306, via the network 112. In the illustrated embodiment, the request can originate from either the payment service 106, at 308, as part of authorizing a payment transaction between the purchasing entity 118 and the merchant 102, or the purchasing entity 118, at 310, independent of the payment transaction with the merchant 102. What's more, when the request originates from the purchasing entity 118, the subsequent transaction between the purchasing entity 118 and the merchant 102 may include the payment device transaction as described above or another type of transaction (e.g., a cash transaction, a barter transaction, etc.). Further, in other embodiments, merchant verification requests may originate from one or more other entities, for example, the acquirer 104 and/or the issuer 108 and/or other entities.

Once the verification request is received by the merchant verification service 110 (at the computing device 200), the merchant verification service 110 searches in the merchant database 116, at 312, for the merchant 102 identified in the request. In particular, the processor 202 of the computing device 200, searches in the merchant database 116 for keywords associated with the merchant 102, for example, the merchant's name (e.g., the merchant's legal name, the merchant's business name (e.g., fictitious name, doing business as (DBA) name, etc.), the merchant's address, the merchant's MID, other (e.g., prior) business names for the merchant 102, names of divisions or other companies associated with the merchant 102, etc. to determine if the merchant 102 is in the database and, thus, poses a transaction risk to the purchasing entity 118. In some aspects, the MID may also be used, by the merchant verification service 110, to help track merchants using different names or merchants that change their names.

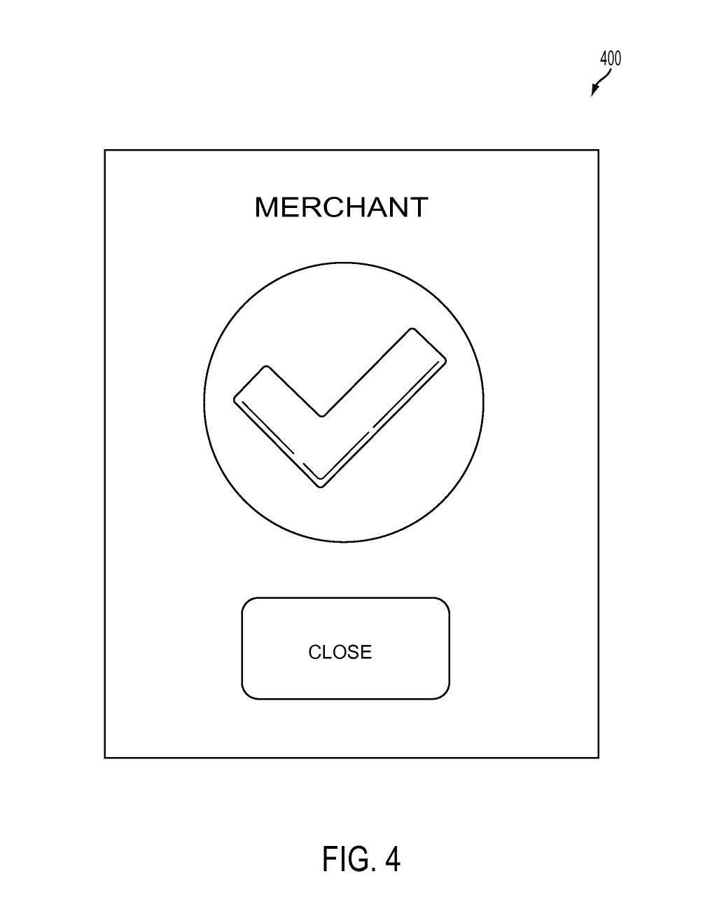

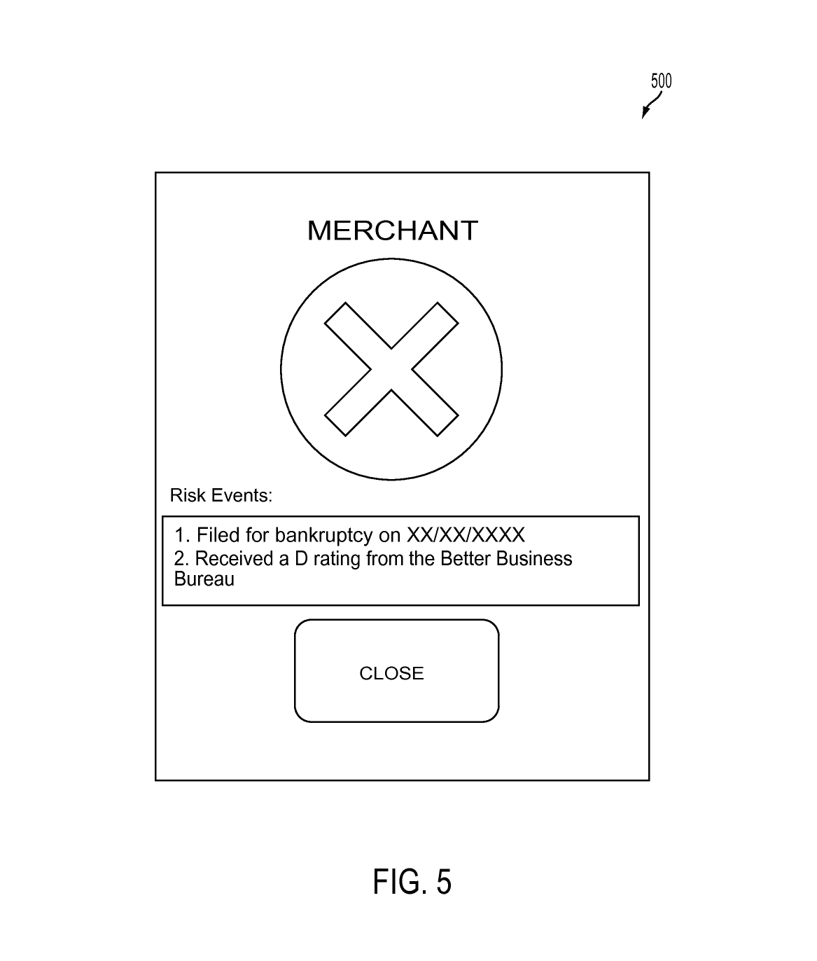

With continued reference to FIG. 3, at 314, for requests that originate directly from the purchasing entity 118, independent of the payment transaction with the merchant 102, the merchant 102 is verified, at 316, when the merchant 102 is not included in the merchant database 116 (i.e., the search, at 312, does not find the merchant 102 in the merchant database 116). Following such verification, a notification is sent via the network 112 to the purchasing entity 118, at 318 (e.g., via email, text message, mail, etc.), indicating that the merchant 102 is not identified as posing a transaction risk. Alternatively, when the search, at 312, identifies the merchant 102 in the merchant database 116, the merchant 102 is flagged by the computing device 200, at 316, and a warning notification is sent via the network 112 to the purchasing entity 118 at 320. As an example, FIG. 4 illustrates an exemplary portion of an interface 400, that can be displayed at the computing device 200 associated with the purchasing entity 118, notifying that that the merchant 102 has been verified. And, FIG. 5 illustrates an exemplary portion of an interface 500 that can be displayed at the computing device 200 associated with the purchasing entity 118 for communicating the warning notification to the purchasing entity 118.

Again, at 314, when requests originate from the payment service 106 in connection with the payment transaction, the merchant 102 is verified, at 322, when the merchant 102 is not included in the merchant database 116. Here, upon verification of the merchant 102 (and in place of a notification indicating that the merchant 102 is not identified as posing a transaction risk), the payment transaction between the purchasing entity 118 and the merchant 102 is simply completed at 324. However, when the search, at 312, identifies the merchant 102 in the merchant database 116, the merchant 102 is flagged by the computing device 200, at 322, and a warning notification is sent via the network 112 to the purchasing entity 118, at 326 (or to the merchant 102, for display to the purchasing entity 118, at a point of sale terminal, etc.). The flag for the merchant 102 and/or the warning notification associated therewith may be stored in memory 204 of the computing device 200, or otherwise stored, in one or more embodiments.

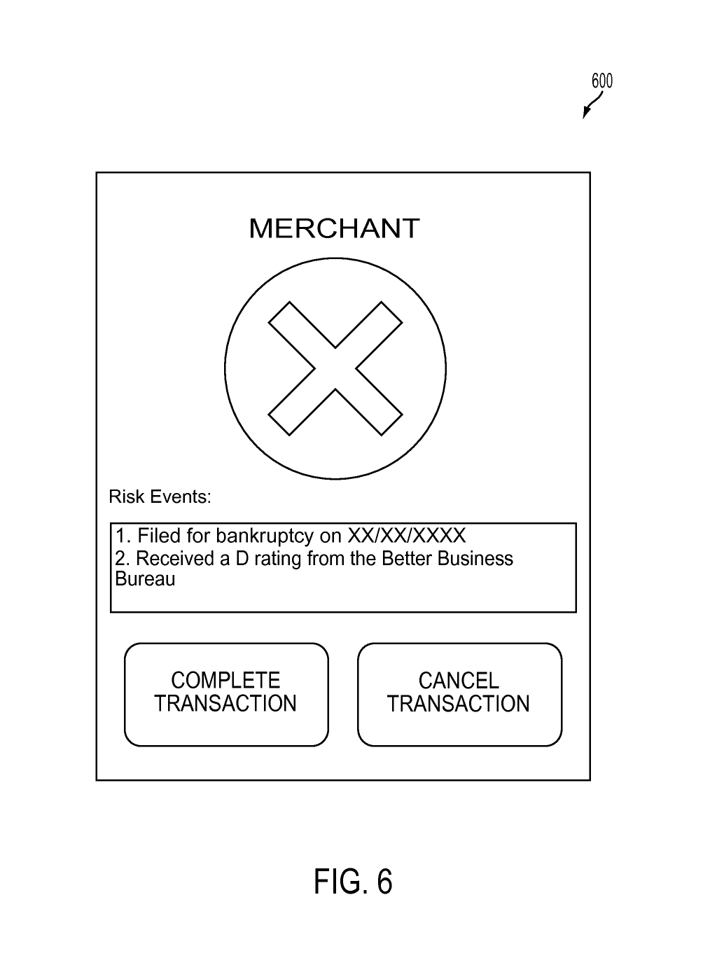

The warning notification includes options, at 328, for the purchasing entity 118 to proceed with (and complete) the transaction, at 324, or cancel the transaction at 330. As an example, FIG. 6 illustrates an exemplary portion of an interface 600 that can be displayed at the computing device 200 associated with the purchasing entity 118 for communicating the warning notification to the purchasing entity 118.

In some embodiments, the computing device 200 associated with the purchasing entity 118 includes a mobile computing device with an application for identifying if the merchant 102 (or any other merchant) poses a transaction risk to the purchasing entity 118 (e.g., in accordance with the system 100, the method 300, etc.). For example, the memory 204 of the computing device 200, and specifically, the non-transitory computer readable media, includes computer-executable instructions that when executed by the processor 202 cause the processor 202 to determine when the merchant 102 poses a transaction risk to the purchasing entity 118. Using the application, which may communicate with the computing device 200 of the merchant verification service 110 via any available communication type (e.g., email, text message, etc.), the purchasing entity 118 may request verification of the merchant 102, view risk events (if any) associated with the merchant 102, and select to complete or cancel the payment transaction when the merchant 102 does in fact pose a transaction risk to the purchasing entity 118. Further, the purchasing entity 118 may use an electronic wallet such as MasterPass, Google Wallet, PayPass, Isis Mobile Wallet®, etc., in connection with the mobile device as a payment means when initiating the payment transaction with the merchant 102. Here, the purchasing entity 118 may then manage verification of merchants, set automatic or manual verifications, and any resulting notifications and communications through the electronic wallet.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) receiving a request to review a merchant, to determine if the merchant poses a transaction risk to a purchasing entity, (b) searching for the merchant in the merchant database, which includes merchant data for multiple merchants that are associated with risk events (e.g., bankruptcy filings, bankruptcy judgments, poor consumer ratings and/or reviews, etc.) indicative that the multiple merchants pose transaction risks to the purchasing entity, (c) flagging the merchant when the merchant is identified in the merchant database, (d) transmitting, to the purchasing entity, a warning notification (e.g., an indication of a risk event associated with the merchant, etc.) when the merchant is flagged, (e) transmitting, to the purchasing entity, a verification notification when the merchant is not identified in the merchant database, and (f) approving the payment transaction when the merchant is not identified in the merchant database.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” or “included with” another element or layer, it may be directly on, engaged, connected or coupled to, or associated with the other element or layer, or intervening elements or layers may be present. As used herein, the term “and/or” includes any and all combinations of one or more of the associated listed items.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for identifying when a first party poses a transaction risk to a second party, the method comprising:
receiving a request to review a first party, to determine when the first party poses a transaction risk to a second party;
searching, by a computing device, for the first party in a database, the database including data for multiple parties that are associated with risk events indicative that the multiple parties pose transaction risks to the second party; and
flagging, by the computing device, the first party when the first party is identified in the database.

2. The method of claim 1, wherein the first party includes a merchant and the second party includes a purchasing entity, and wherein receiving the request includes receiving the request in connection with a payment transaction between the purchasing entity and the merchant, and prior to completion of the payment transaction;
the method further comprising transmitting, to the purchasing entity, a warning notification when the merchant is flagged by the computing device, as being identified in the database.

3. The method of claim 2, wherein the warning notification includes an indication of a risk event associated with the merchant.

4. The method of claim 3, wherein the risk event includes one or more of a bankruptcy filing and a bankruptcy judgment.

5. The method of claim 2, wherein the warning notification includes an option for the purchasing entity to cancel the transaction, upon receipt of the warning notification.

6. The method of claim 2, further comprising approving the payment transaction when the merchant is not identified in the merchant database.

7. The method of claim 1, wherein the first party includes a merchant and the second party includes a purchasing entity, and wherein receiving the request includes receiving the request from a purchasing entity independent of a payment transaction between the purchasing entity and the merchant;
the method further comprising transmitting, to the purchasing entity, a warning notification when the merchant is flagged.

8. The method of claim 7, further comprising transmitting, to the purchasing entity, a verification notification when the merchant is not identified in the merchant database.

9. The method of claim 1, wherein the first party includes a merchant and the second party includes a purchasing entity, and wherein the risk events include one or more of a bankruptcy filing and a bankruptcy judgment.

10. A system for identifying when a target merchant poses a transaction risk to a purchasing entity, the system comprising:
a merchant database configured to store merchant data for multiple merchants, the merchant data for at least one of the multiple merchants including a risk event indicative that the merchant poses a transaction risk to the purchasing entity; and
a processor coupled to the merchant database, and configured to:
in response to a request to review the target merchant, search in the merchant database for the target merchant;
when merchant data for the target merchant includes a risk event, generate a flag for the target merchant; and
when the target merchant is flagged, cause a warning notification to display, thereby, indicating that the target merchant poses a transaction risk to the purchasing entity.

11. The system of claim 10, wherein the request to review the target merchant is associated with a payment transaction between the purchasing entity and the target merchant; and
wherein the processor is configured to cause the warning notification to display to the purchasing entity prior to completion of the payment transaction.

12. The system of claim 11, wherein the processor is configured to cause the warning notification to display on a mobile communication device associated with the purchasing entity.

13. The system of claim 11, wherein the warning notification includes an indication of the risk event associated with the merchant.

14. The system of claim 13, wherein the risk event includes one or more of a bankruptcy filing and a bankruptcy judgment.

15. The system of claim 11, wherein the warning notification includes an option for the purchasing entity to cancel the payment transaction.

16. The system of claim 10, wherein the processor is further configured to approve the payment transaction when the merchant is not identified in the merchant database.

17. The system of claim 10, wherein the request to review the target merchant is independent of a payment transaction between the purchasing entity and the target merchant; and
wherein the processor is configured to cause the warning notification to display on a mobile computing device associated with the purchasing entity.

18. The system of claim 17, wherein the processor is further configured to transmit to the purchasing entity, a verification notification when the merchant is not identified in the merchant database.

19. A non-transitory computer readable media comprising instructions that, when executed by at least one processor, cause the at least one processor to:
receive a request to review a target merchant in connection with a payment transaction between a purchasing entity and the target merchant, to determine if the target merchant poses a transaction risk to the purchasing entity;
search for the target merchant in a merchant database including multiple merchants that are each associated with a risk event indicative that the merchant poses a transaction risk to the purchasing entity;
generate a flag for the target merchant when the target merchant is identified in the merchant database; and
cause a warning notification to display when the target merchant is flagged, indicating that the target merchant poses a transaction risk to the purchasing entity.

20. The non-transitory computer readable media of claim 19, wherein the risk event includes one or more of a bankruptcy filing and a bankruptcy judgment.
